(19) United States
(12) Patent Application Publication
(10) Pub. No.: US 2018/0367359 A1
(43) Pub. Date: Dec. 20, 2018

(54) WIRELESS COMMUNICATION DEVICE AND WIRELESS COMMUNICATION METHOD

(71) Applicant: KABUSHIKI KAISHA TOSHIBA, Tokyo (JP)

(72) Inventors: Koji AKITA, Yokohama (JP); Tomoya TANDAI, Tokyo (JP); Daisuke UCHIDA, Kawasaki (JP); Daiki YODA, Yokohama (JP)

(73) Assignee: KABUSHIKI KAISHA TOSHIBA, Tokyo (JP)

(21) Appl. No.: 15/898,343

(22) Filed: Feb. 16, 2018

(30) Foreign Application Priority Data
Jun. 16, 2017 (JP) 2017-118939

(51) Int. Cl. H04L 27/26; H04L 5/00

(52) U.S. Cl. CPC H04L 27/2662; H04L 27/2671; H04L 27/2649; H04L 27/2607; H04L 5/0007

(57) ABSTRACT

A wireless communication device according to an aspect of the present invention includes a transmitter, a receiver, and a signal processor. The transmitter transmits a first OFDM signal. The receiver receives a second OFDM signal. The signal processor detects a first timing that is a symbol timing for the first OFDM signal, detects a second timing that is a symbol timing for the second OFDM signal, determines a setup value for a symbol length of a new first OFDM signal on the basis of the first timing and the second timing, and generates the new first OFDM signal, the symbol length of which is adjusted to the setup value.

### CROSS-REFERENCE TO RELATED APPLICATION (S)

This application is based upon and claims the benefit of priority from Japanese Patent Application No. 2017-118939, filed Jun. 16, 2017; the entire contents of which are incorporated herein by reference.

### FIELD

Embodiments described herein relate generally to a wireless communication device and a wireless communication method.

### BACKGROUND

There is known a wireless communication method, such as Frequency Division Duplex (FDD), which does not use different time slots for transmission and reception. A wireless communication device using such a wireless communication method can continuously perform transmission and reception and can reduce a transmission delay. However, if a signal associated with transmission leaks around to a reception circuit or the like when transmission and reception are simultaneously performed, the leak signal may interfere with a received signal to cause the problem of reduction in communication quality.

To reduce a leak signal, required isolation between a transmission system and a reception system needs to be ensured. However, as communication distance increases, a difference in intensity between radio waves associated with transmission and radio waves associated with reception increases, and required isolation increases. For this reason, an increase in communication distance makes ensuring of isolation more difficult.

### BRIEF DESCRIPTION OF THE DRAWINGS

FIG. 1 is a conceptual diagram illustrating an example of a wireless communication system according to a first embodiment;

FIG. 2 is a diagram for explaining a configuration of an OFDM signal;

FIG. 3 is a diagram for explaining a range covered by a signal acquired at the time of OFDM reception signal demodulation;

FIG. 4 is a diagram for explaining demodulation of an OFDM reception signal and a leak signal;

FIG. 5 is a chart illustrating constellations of an OFDM reception signal and a leak signal;

FIG. 6 is a diagram for explaining a cause of an offset;

FIG. 7 is a block diagram illustrating an example of a configuration of a signal processor in a wireless communication device according to the first embodiment;

FIG. 8 is a chart illustrating an example of a schematic flowchart of a process of determining a symbol length of an OFDM transmission signal by the signal processor according to the first embodiment;

FIG. 9 is a graph illustrating a relationship between SIR and block error rate;

FIG. 10 is a graph illustrating a relation between offset and block error rate;

FIG. 11 is a chart illustrating an example of a sequence for a case where a wireless communication device transmits a transmission stop signal;

FIG. 12 is a chart illustrating an example of a sequence for a case where two wireless communication devices come into coincidence in symbol length;

FIG. 13 is a diagram illustrating an offset when transmission timings for an OFDM transmission signal are in synchronization; and

FIG. 14 is a diagram illustrating an offset when the transmission timings for an OFDM transmission signal are out of synchronization.

### DETAILED DESCRIPTION

A wireless communication device according to an embodiment of the present invention reduces influence of a leak signal.

A wireless communication device according to an aspect of the present invention includes a transmitter, a receiver, and a signal processor. The transmitter transmits a first OFDM signal. The receiver receives a second OFDM signal. The signal processor detects a first timing that is a symbol timing for the first OFDM signal, detects a second timing that is a symbol timing for the second OFDM signal, determines a setup value for a symbol length of a new first OFDM signal on the basis of the first timing and the second timing, and generates the new first OFDM signal, the symbol length of which is adjusted to the setup value.

Below, a description is given of embodiments of the present invention with reference to the drawings. The present invention is not limited to the embodiments.

### First Embodiment

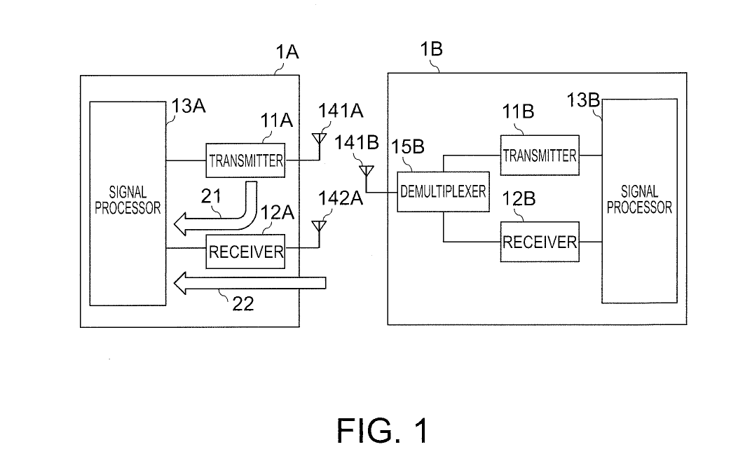

FIG. 1 is a conceptual diagram illustrating an example of a wireless communication system according to a first embodiment.

The wireless communication system according to the present embodiment includes two or more wireless communication devices 1 which perform wireless communication. In FIG. 1A, wireless communication device 1A and a wireless communication device 1B are illustrated.

Incidentally, an alphabetical suffix is added for identification. Processing details of components having the same reference numeral are the same even if the components are different in alphabetical suffix. The same applies hereinafter.

It is assumed that the wireless communication device 1 according to the present embodiment performs full duplex communication using Frequency Division Duplex (FDD). It is also assumed that the wireless communication device 1 according to the present embodiment perform data transmission and reception using Orthogonal Frequency Division Multiplexing (OFDM).

Incidentally, OFDM may not be used for a signal associated with wireless communication device control, such as an order to a different wireless communication device.

The wireless communication device 1 includes a transmitter 11 which transmits a signal, a receiver 12 which receives a signal, a signal processor 13 which performs processing on signals associated with transmission and reception, and an antenna 14 which at least transmits or receives radio waves. The configurations of the wireless communication devices 1 belonging to the wireless communication system according to the present embodiment may be the same or different. For example, the wireless communication device 1A in FIG. 1 includes a transmitter 11A, a receiver 12A, a signal processor 13A, and antennas 141A and 142A. The wireless communication device 1B in FIG. 1 includes a transmitter 11B, a receiver 12B, a signal processor 13B, an antenna 141B, and a demultiplexer 15B.

The transmitter 11 and the receiver 12 of the wireless communication device 1 are separated for implementation of FDD. As in the wireless communication device 1A, the transmitter 11 and the receiver 12 may have respective dedicated antennas as long as the transmitter 11 and the receiver 12 are separated. As in the wireless communication device 1B, a demultiplexer may be provided, and one antenna may be shared.

Even if the transmitter 11 and the receiver 12 are separated, a phenomenon may occur in which an OFDM signal associated with transmission, i.e., an OFDM signal to be transmitted or a transmitted OFDM signal leaks around to the receiver 12. For example, if the antenna 142A connected to the receiver 12A receives a radio wave associated with an OFDM signal emitted from the antenna 141A, the above-described phenomenon occurs. For example, if an OFDM signal to be transmitted from the transmitter 11 enters into the receiver 12 when the transmitter 11 and the receiver 12 are insufficiently separated (e.g., the transmitter 11 and the receiver 12 are installed close to each other), the phenomenon occurs. For example, if a signal transmitted by the transmitter 11B enters into the receiver 12B via the demultiplexer 15B due to insufficient separation by the demultiplexer 15B, the phenomenon occurs. Since transmission and reception are simultaneously performed in FDD, an OFDM signal associated with transmission leaks around to the receiver 12 to result in interference with a received OFDM signal. An OFDM signal having leaked around to the receiver 12 and an OFDM signal received by the receiver 12 are indicated by arrows 21 and 22, respectively, in FIG. 1. This causes a situation in which communication quality of the wireless communication system decreases.

Hereinafter, an OFDM signal associated with transmission will be referred to as an OFDM transmission signal. A received OFDM signal will be referred to as an OFDM reception signal. An OFDM transmission signal having leaked around to the receiver 12 will be referred to as a leak signal.

For this reason, the signal processor 13 of the wireless communication device 1 according to the present embodiment performs processing for reducing influence of a leak signal. More specifically, the signal processor 13 reduces influence of a leak signal by adjusting a length for an OFDM transmission signal.

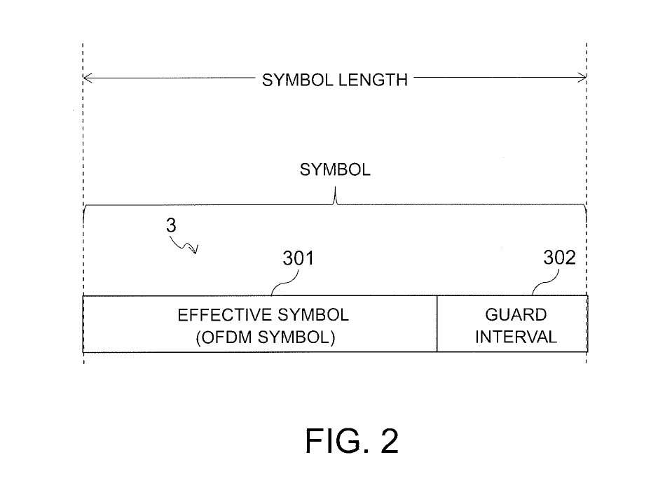

An OFDM signal will be described before describing details of processing by the signal processor 13. FIG. 2 is a diagram for explaining a configuration of an OFDM signal. An effective symbol (OFDM symbol) 301 and a guard interval 302 are illustrated in FIG. 2. As in FIG. 2, an OFDM signal includes a signal having an effective symbol and a guard interval added thereto. Incidentally, one signal composed of one effective symbol and one guard interval will be hereinafter referred to as a symbol. A length of one symbol will be referred to as a symbol length.

An effective symbol is a signal which is generated by allocating signals to be modulated to a plurality of continuous frequency bands and performing inverse Fourier transforms on the signals. The effective symbol is a part related to data.

A guard interval is a signal for preventing symbols from interfering with each other due to, e.g., a propagation delay time period. A guard interval is inserted for each symbol. A signal which is a copy of a part of an effective symbol, a signal obtained by changing the part through filtering or the like, a signal with an amplitude of 0, or the like is used as a guard interval. Incidentally, if a signal with an amplitude of 0 is used as a guard interval, the guard interval is provided at an end of a symbol.

To extract a signal before modulation from an OFDM reception signal, the OFDM reception signal needs to be demodulated. At the time of demodulation of an OFDM reception signal, a signal identical in length to an effective symbol is taken out from the OFDM reception signal, and a Fourier transform is performed on the taken-out signal. Incidentally, an OFDM reception signal may fail to be demodulated depending on a range covered by a taken-out signal.

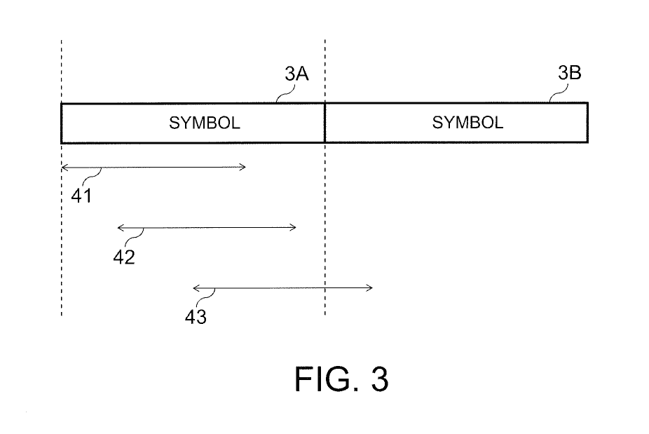

FIG. 3 is a diagram for explaining a range covered by a signal acquired at the time of OFDM reception signal demodulation. In FIG. 3, two symbols (a symbol 3A and a symbol 3B) are illustrated. Arrows 41, 42, and 43 illustrated in FIG. 3 indicate ranges covered by signals acquired for demodulation. Lengths of the arrows are the same as a length of an effective symbol.

If a signal fits within one symbol, the signal being acquired by acquiring a signal identical in length to an effective symbol and performing a Fourier transform, an OFDM reception signal can be demodulated. Referring to FIG. 3, if a signal covering the range indicated by the arrow 41 or 42 is acquired, since the acquired signal fits within one symbol, and an OFDM reception signal is regenerated (demodulated).

On the other hand, if an acquired signal does not fit within one symbol, i.e., a signal extending across two symbols is acquired, it is difficult to demodulate an OFDM reception signal with high accuracy. In FIG. 3, if a signal covering the range indicated by the arrow 43 is acquired, an OFDM reception signal is not normally regenerated. An acquired signal extending across two symbols is a signal which is obtained by adding parts of the two symbols. The signal fluctuates more greatly in amplitude after a Fourier transform than the acquired signals covering the ranges indicated by the arrows 41 and 42 and has a high probability of having a large amplitude. Regeneration from the signal is thus difficult. As described above, a signal extending across two symbols is not used to correctly regenerate an OFDM signal.

The above-described acquisition range for correctly regenerating an OFDM signal also applies to a leak signal. If a temporal position of a symbol as an OFDM reception signal does not coincide with a temporal position of a symbol as a leak signal, i.e., if the OFDM reception signal is not temporally coincident with the leak signal, it is impossible to demodulate both the OFDM reception signal and the leak signal. Regeneration of the OFDM reception signal is thus difficult.

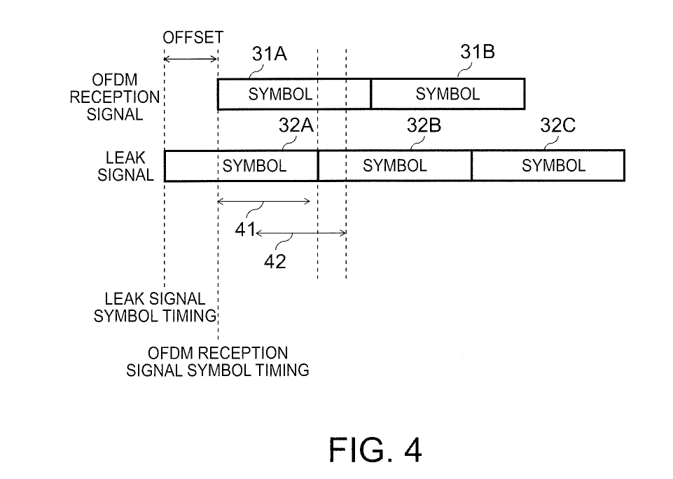

FIG. 4 is a diagram for explaining demodulation of an OFDM reception signal and a leak signal. Upper symbols (31A and 31B) in FIG. 4 are OFDM reception signals, and lower symbols (32A, 32B, and 32C) are leak signals.

Assume that symbols as OFDM reception signals and symbols as leak signals are different in temporal position (e.g., symbol beginning), as illustrated in FIG. 4. Incidentally, a temporal reference position for a symbol may be defined as appropriate. The temporal reference position may be a beginning or a center of the symbol or may be a beginning of a guard interval. A temporal reference position of a symbol will be hereinafter referred to as a symbol timing. A difference between a symbol timing for an OFDM reception signal and a symbol timing for a leak signal will be referred to as an offset.

As described with reference to FIG. 3, for OFDM reception signal demodulation, a signal identical in length to an effective symbol within one symbol as an OFDM reception signal is subjected to a Fourier transform. If only OFDM reception signals are present, an OFDM reception signal is regenerated by demodulating a signal acquired so as to cover the range indicated by the arrow 41 or 42. However, if leak signals illustrated in FIG. 4 are also present, the range indicated by the arrow 42 extends across two symbols as leak signals. Even if a signal acquired so as to cover the range indicated by the arrow 42 is demodulated, the demodulated signal is greatly influenced by leak signal interference. Thus, an OFDM reception signal cannot be demodulated with high accuracy, and the communication quality may decrease greatly.

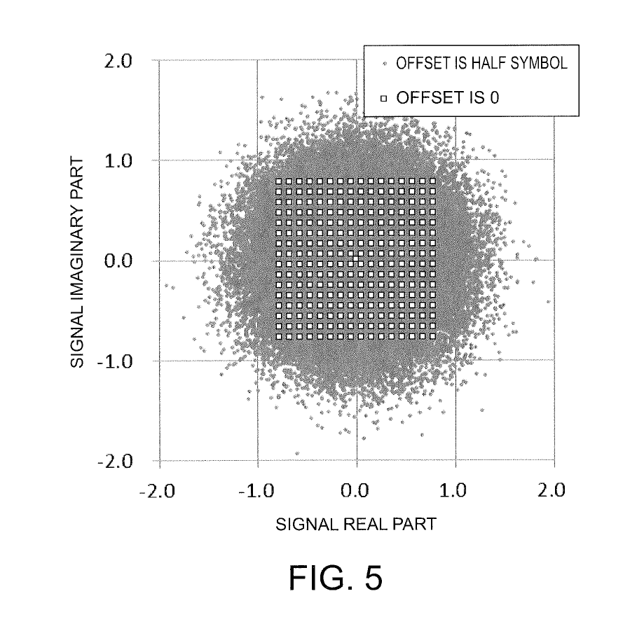

FIG. 5 is a chart illustrating constellations of an OFDM reception signal and a leak signal. Assume that subcarriers for an OFDM signal are subjected to modulation using 256-QAM (Quadrature Amplitude Modulation). Open squares in FIG. 5 form a constellation in a case where the leak signal and the OFDM signal are in synchronization, and an offset between the leak signal and the OFDM signal is 0. Black circles in FIG. 5 form a constellation in a case where the offset is about half a symbol length.

In the case where the leak signal and the OFDM signal are in synchronization, an original modulation constellation is restored, and an amplitude of the leak signal is kept not more than an allowable value. In contrast, in the case where the signals are out of synchronization, dispersion in the amplitude of the leak signal is wide, and interference by a large amplitude may degrade the OFDM reception signal.

An offset between an OFDM reception signal and a leak signal arises from a symbol length and a propagation delay time period which is a time period from when an OFDM signal is transmitted to when the OFDM signal is received by a communication partner. If the propagation delay time period is equal to an integer multiple of the symbol length, there is no offset. If the propagation delay time period is not equal to an integer multiple of the symbol length, there is an offset.

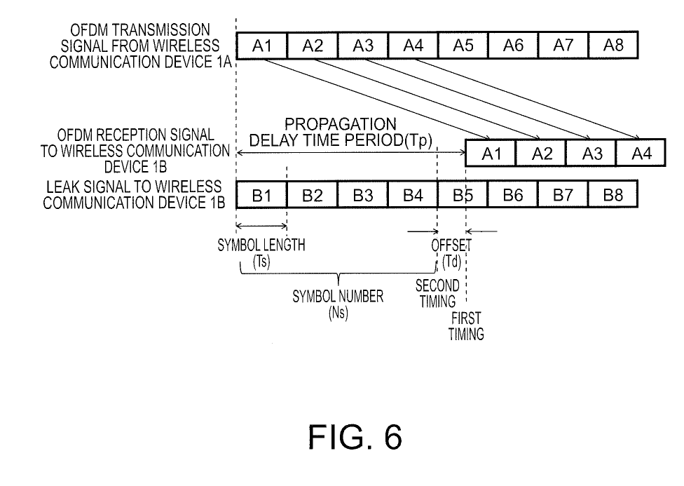

FIG. 6 is a diagram for explaining a cause of an offset. The wireless communication device 1A and the wireless communication device 1B are communicating with each other using OFDM signals. An OFDM transmission signal from the wireless communication device 1A is received by the wireless communication device 1B after a lapse of a propagation delay time period. That is, an OFDM transmission signal from the wireless communication device 1A becomes an OFDM reception signal to the wireless communication device 1B after a lapse of the propagation delay time period. The wireless communication device 1B accepts both the OFDM reception signal and a leak signal after the lapse of the propagation delay time period.

In the example in FIG. 6, a symbol timing (first timing) for an OFDM reception signal is not coincident with a symbol timing (second timing) for a leak signal, and there is an offset. Such an offset occurs because a length of the propagation delay time period is not an integer multiple of the symbol length. An absolute value of the offset decreases with a reduction in a difference between the length of the propagation delay time period and an integer multiple of the symbol length.

For this reason, the signal processor 13 determines a symbol length of an OFDM transmission signal such that the absolute value of the offset is smaller than a current absolute value. Even if a range covered by a signal to be acquired is determined on the basis of the symbol timing for an OFDM reception signal, the probability of the range fitting within one symbol as a leak signal increases with a reduction in the absolute value of the offset. The probability that an amplitude of a leak signal subjected to a Fourier transform increases can be reduced, and influence of interference by a leak signal on an OFDM reception signal can be reduced. In this manner, the wireless communication device 1 according to the present embodiment can prevent a reduction in communication quality.

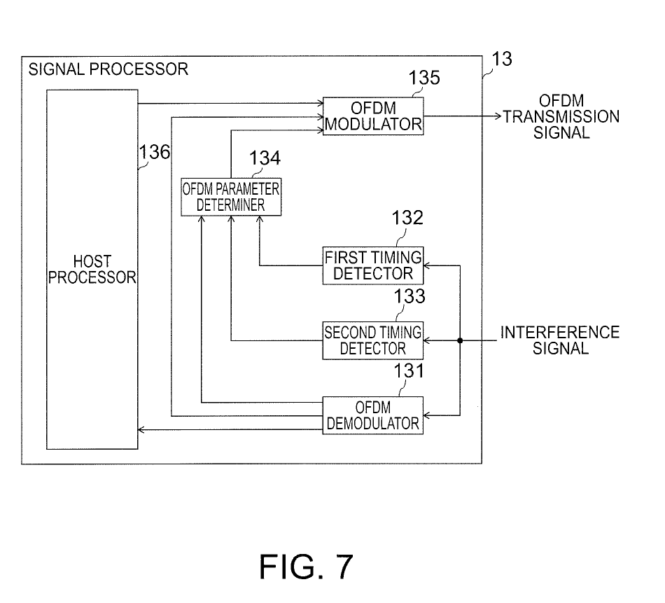

An internal configuration of the signal processor 13 will be described. FIG. 7 is a block diagram illustrating an example of a configuration of the signal processor 13 in the wireless communication device 1 according to the first embodiment. The signal processor 13 includes an OFDM demodulator 131, a first timing detector 132, a second timing detector 133, an OFDM parameter determiner 134 (a symbol length determiner), an OFDM modulator 135, and a host processor 136.

The OFDM demodulator 131 receives a signal which is generated due to interference by a leak signal with an OFDM reception signal and demodulates the OFDM reception signal and the leak signal. A signal which is generated due to interference by a leak signal with an OFDM reception signal will be hereinafter referred to as an interference signal. A range covered by a signal which is acquired for demodulation may be defined in advance or may be designated by a different component or a different wireless communication device. The signals demodulated by the OFDM demodulator 131 are sent to the host processor 136.

The OFDM demodulator 131 may also pass information included in the demodulated signals to the OFDM parameter determiner 134, the OFDM modulator 135, or both. For example, a symbol number (to be described later) included in the OFDM reception signal may be passed to the OFDM parameter determiner 134.

The first timing detector 132 detects a symbol timing for a leak signal from the interference signal. The second timing detector 133 detects a symbol timing for an OFDM reception signal from the interference signal. Incidentally, one timing detector may detect both the symbol timing for a leak signal and the symbol timing for an OFDM reception signal.

A well-known method may be used as a method for symbol timing detection. For example, the fact that a part of a signal as an effective symbol is used as a signal as a guard interval may be used. For example, a delay autocorrelation technique, a cross-correlation technique, or the like may be used. A delay autocorrelation technique detects a symbol timing by calculating a correlation between a signal used for detection and a signal obtained by delaying the signal used for detection. A cross-correlation technique detects a symbol timing by calculating a correlation between a signal used for detection and a known signal if the known signal is included in a part of the signal for detection.

In a case using the above-described technique, a known signal which improves a correlation characteristic may be included in an OFDM signal to facilitate judgment of presence or absence of correlation. A signal which improves a correlation characteristic is a signal which lowers a value of correlation between a signal used for detection and a signal obtained by delaying the signal used for detection.

Whether to include a known signal which improves a correlation characteristic may be defined in advance or may be judged by the OFDM parameter determiner 134.

The OFDM parameter determiner (symbol length determiner) 134 calculates an offset between the leak signal and the OFDM reception signal using the symbol timing for a leak signal and the symbol timing for a OFDM reception signal. The OFDM parameter determiner 134 then determines a symbol length of an OFDM transmission signal on the basis of the calculated offset. Various methods are conceivable as a symbol length determination method. Examples of the symbol length determination method will be described below.

### (First Symbol Length Determination Method)

In the present method, the OFDM parameter determiner 134 changes a symbol length on the basis of a variation between an offset calculated this time and a previously calculated offset. An offset between a leak signal derived from an OFDM transmission signal with a new symbol length and an OFDM reception signal is calculated, and the symbol length of an OFDM transmission signal is changed again. That is, a method is conceivable in which a result of a variation in symbol length is fed back as a variation in offset, which brings the symbol length closer to an appropriate symbol length. Incidentally, an increment and a decrement for the symbol length to be changed by the OFDM parameter determiner 134 may be defined in advance. Alternatively, the increment and the decrement for the symbol length may be calculated on the basis of the amount of variation in offset. If an offset falls below a predetermined desired value, the OFDM parameter determiner 134 may stop determination (change) of the symbol length.

### (Second Symbol Length Determination Method)

In the present method, the OFDM parameter determiner 134 calculates an appropriate symbol length on the basis of an offset.

For example, if the wireless communication device 1 is fixed, a propagation delay time period is constant. Thus, if the wireless communication device 1 is fixed, the OFDM parameter determiner 134 may calculate an offset on the basis of the fixed propagation delay time period.

As illustrated in FIG. 6, let Td be an offset; Tp, a propagation delay time period; and Ts, a symbol length of an OFDM transmission signal and a leak signal. For convenience of illustration, the offset Td is a difference obtained by subtracting a symbol timing for an OFDM reception signal from a symbol timing for a leak signal, as illustrated in FIG. 6. Let Ns be the number of symbols (hereinafter referred to as a symbol number) as leak signals included in a period corresponding to the propagation delay time period Tp. A relational expression for the variables is given as follows:

Td=Tp−Ts×Ns (1)

The symbol length Ts may be determined using the relational expression such that the offset Td has a small absolute value.

For example, a plurality of symbol lengths may be set, and a propagation delay time period may be calculated from a variation in offset. First, the symbol length Ts is set to a constant Ts1, and a corresponding offset Td1 is measured. The symbol length Ts is then set to a constant Ts2, and a corresponding offset Td2 is measured. In these case, the following expressions hold:

Td1=Tp−Ts1×Ns (2)

Td2=Tp−Ts2×Ns (3)

A difference between Expressions 2 and 3 is as follows:

(Td1−Td2)=−(Ts1−Ts2)×Ns (4)

Since the symbol lengths Ts1 and Ts2 and the offsets Td1 and Td2 are known, the symbol number Ns is calculated. When the symbol number Ns is calculated, the propagation delay time period Tp can be calculated using Expression (2) or (3).

When the symbol number Ns and the propagation delay time period Tp are calculated in the above-described manner, the symbol length Ts that reduces the absolute value of the offset Td can be calculated. For example, if the propagation delay time period Tp is calculated to be 1010, and the symbol number Ns is calculated to be 10 in accordance with the above-described procedure, Expression (1) is calculated as follows:

Td=Tp−Ts×Ns=1010−Ts×10=(101−Ts)×10 (5)

Thus, if the symbol length Ts is set to 101, the offset Td is 0, and the absolute value of the offset Td can be minimized.

### (Third Symbol Length Determination Method)

A method is also conceivable in which a symbol number is assigned to each symbol as an OFDM reception signal, and a propagation delay time period is estimated and calculated from the symbol numbers.

A symbol number is an identifier for symbol identification. The symbol number Ns can be estimated from symbol numbers. In FIG. 6, a character string described in a symbol and including a numeral indicates a symbol number. Incidentally, the letter A in a symbol means that the symbol is a symbol generated by the wireless communication device 1A and that the letter B in a symbol means that the symbol is a symbol generated by the wireless communication device 1B.

For example, the wireless communication device 1A and the wireless communication device 1B assign symbol numbers and transmit OFDM signals at the same timing. After that, the wireless communication device 1B having received an OFDM signal recognizes that symbol A1 as an OFDM reception signal overlaps with symbol B5 as a leak signal. Thus, the wireless communication device 1B calculates the symbol number Ns to be 4. When the symbol number Ns is calculated in this manner, the propagation delay time period Tp can be calculated using Expression (1). The symbol length Ts that reduces the absolute value of the offset can be calculated in the same manner as described above.

### (Fourth Symbol Length Determination Method)

The propagation delay time period Tp may be estimated not from symbol numbers but from a communication distance. Expression (1) is organized in terms of the propagation delay time period Tp as follows:

Tp=Td+Ts×Ns (6)

It is clear from Expression (6) that the propagation delay time period Tp is a sum of the offset Td and an integer multiple of the symbol length Ts. If the offset Td is calculated from the symbol timing for a leak signal and the symbol timing for an OFDM reception signal, when the communication distance is known to an accuracy of a distance corresponding to the symbol length Ts, the symbol number Ns can be estimated, and the propagation delay time period Tp can be estimated.

For example, assume that the offset Td is already calculated and that the symbol length Ts is one μsec. An electromagnetic wave travels at 300 m/μsec. In this case, if an error in estimated communication distance is less than 300 m, an error in the propagation delay time period Tp is less than one μsec, and the symbol number Ns that is an integer can be estimated.

The communication distance may be estimated by the wireless communication devices 1 transmitting pieces of information on their positions to each other. Alternatively, the communication distance may be estimated from a communication distance or information on a position of a communication partner received from a different communication device, such as a server which manages the wireless communication system. The position of the wireless communication device 1 may be measured and stored in advance or may be calculated using a position detection method, such as a navigation satellite system.

By the above-described determination methods, the OFDM parameter determiner 134 may determine a value (setup value) for a symbol length of an OFDM transmission signal. The OFDM parameter determiner 134 may use one determination method or may select an optimum result among results of calculation by the determination methods.

To adjust the symbol length of an OFDM transmission signal to the setup value determined by the OFDM parameter determiner 134, a length for an effective symbol, a length for a guard interval, or both may be adjusted. For example, if the symbol length is desired to be shortened by a length about 10 times a wavelength, the length for an effective symbol may be shortened by a length about 8 times the wavelength, and the length for a guard interval may be shortened by a length about two times the wavelength. As described above, the both lengths may be changed. Alternatively, the symbol length may be changed to a desired length by lengthening one and shortening the other. For example, the symbol length may be shortened by the length about 10 times the wavelength by shortening the length for an effective symbol by a length about 16 times the wavelength and lengthening the length for a guard interval by the length about six times the wavelength.

Incidentally, only the length for a guard interval is preferably adjusted. As described earlier, since a guard interval is, for example, a signal which is a copy of a part of an effective symbol, the length for a guard interval can be adjusted without changing a method for effective symbol generation. For this reason, an OFDM transmission signal can be more easily generated if the length for an effective symbol is not changed.

The OFDM modulator 135 modulates a signal acquired from the host processor 136 into an OFDM signal using a setup value notified by the OFDM parameter determiner 134. Conceivable setup values notified by the OFDM parameter determiner 134 include a setup value for the symbol length, a setup value for the length for an effective symbol, and a setup value for the length for a guard interval. With the setup value, a symbol has a desired length. Incidentally, a parameter for an OFDM transmission signal other than a parameter associated with the symbol length may be notified by the OFDM parameter determiner 134 to the OFDM modulator 135.

The host processor 136 receives a signal demodulated by the OFDM demodulator 131 and processes the signal. The host processor 136 also passes a signal before modulation to be sent to a communication partner to the OFDM modulator 135. Processing by the host processor 136 is the same as processing by a known wireless communication device and is irrelevant to a process of reducing influence of a leak signal. A description of the processing will thus be omitted.

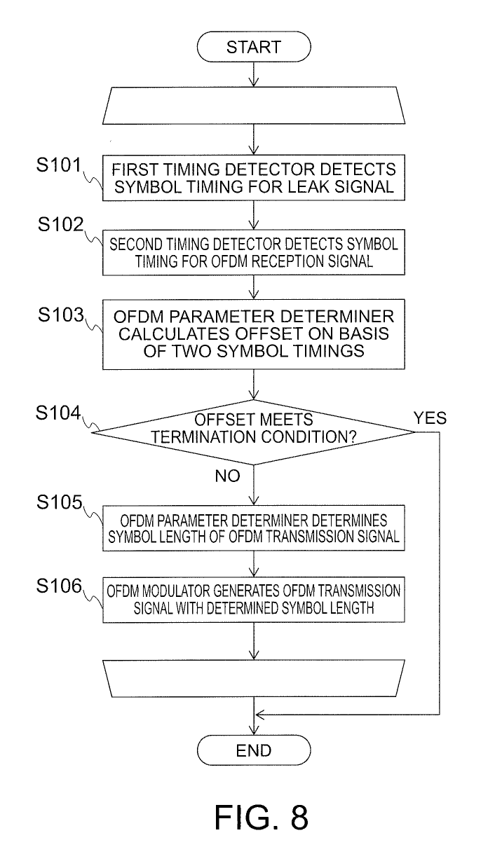

The flow of processing by the components will be described. FIG. 8 is a chart illustrating an example of a schematic flowchart of a process of determining the symbol length of an OFDM transmission signal by the signal processor 13 according to the first embodiment. The flow illustrates a case using the method described as the first symbol length determination method that brings the symbol length closer to an appropriate symbol length by repeating change of the symbol length.

The first timing detector 132 detects a symbol timing for a leak signal from an interference signal (S101). The second timing detector 133 detects a symbol timing for an OFDM reception signal from the interference signal (S102). The OFDM parameter determiner 134 calculates an offset between the leak signal and the OFDM reception signal on the basis of the symbol timing for the leak signal and the symbol timing for the OFDM reception signal (S103).

If the calculated offset meets a termination condition (YES in S104), since an appropriate symbol length is assumed to be already set, the flow ends. On the other hand, if the calculated offset does not meet the termination condition (NO in S104), the OFDM parameter determiner 134 determines (changes) the symbol length of an OFDM transmission signal (S105). The OFDM modulator 135 modulates a signal from the host processor 136 such that the signal has the determined symbol length to generate an OFDM transmission signal (S106). The flow returns to the process of S101. The processes are repeated until the calculated offset meets the termination condition.

Incidentally, the flowchart is just an example and that the order of processes is not limited as long as a required processing result can be obtained. For example, the process of S101 and the process of S102 may be interchanged. A processing result of each process is sequentially stored in a storage (not illustrated), and each component may refer to the storage and acquire a processing result.

Incidentally, a case using any one of the second to fourth symbol length determination methods does not include the branching in S104, and the process of S105 follows the process of S103. No repetition is needed, and the flow ends after the process of S106.

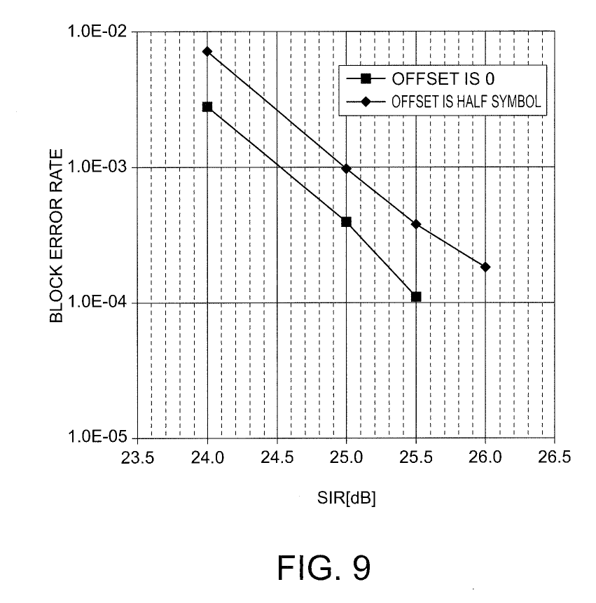

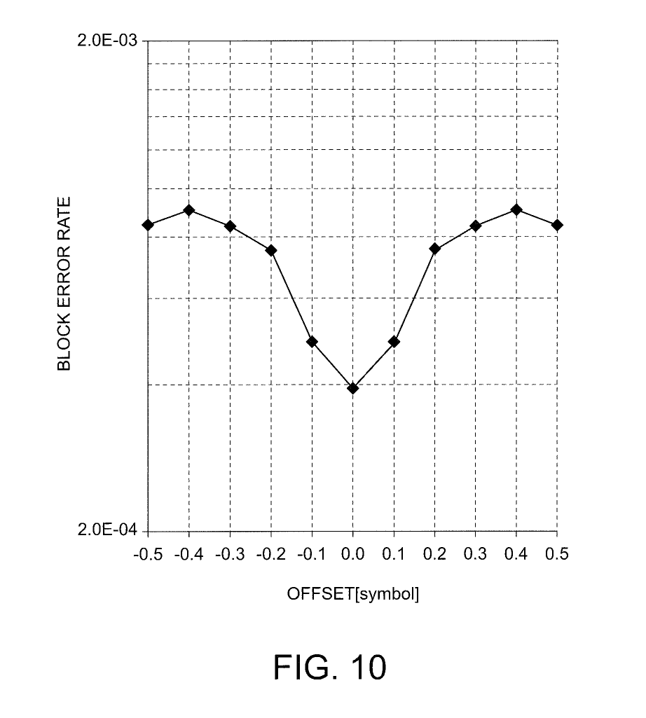

In the above-described manner, an absolute value of an offset is reduced, which makes the communication quality better than before the reduction. FIGS. 9 and 10 are graphs illustrating results of communication quality evaluation by simulation. FIG. 9 is a graph illustrating a relationship between signal to interference ratio (SIR) and block error rate. FIG. 10 is a graph illustrating a relationship between offset and block error rate. FIG. 10 illustrates a case where an SIR is set to 25 dB.

The simulation was performed on the assumption that a wireless communication system for a 5G backhaul having a communication distance of 5 km and an effective symbol length of 760 nsec was adopted as an example of a case where the wireless communication device 1 is fixed. In this case, an OFDM reception signal and a leak signal can be brought into synchronization with an accuracy of about 0.01 symbols.

As illustrated in FIG. 9, performance is higher by 0.5 dB or more in a case without an offset than in a case with an offset about half a symbol length. As illustrated in FIG. 10, when a value for an offset changes from −0.1 to −0.2 and when the value for the offset changes from 0.1 to 0.2, a block error rate rises sharply. It is clear that the block error rate is kept low when the value for the offset is within a range from −0.1 to 0.1. As described above, a reduction in communication quality can be prevented by keeping an absolute value of an offset not more than a constant value.

As described above, the wireless communication device 1 according to the present embodiment can cause a symbol timing for an OFDM reception signal to coincide with a symbol timing for a leak signal. For this reason, the wireless communication device 1 according to the present embodiment can reduce influence of a leak signal and prevent a reduction in communication quality. Also, isolation used to reduce a leak signal can be reduced.

In the wireless communication device 1 according to the present embodiment, both the timings are brought into synchronization by adjusting a length for a guard interval. It is thus possible to easily reduce influence of a leak signal without the need to greatly change settings of the wireless communication device 1.

Incidentally, the components of the wireless communication device 1 described above are just examples and that other components necessary for wireless communication are omitted. For example, the signal processor 13 of the wireless communication device 1 may include a storage which is implemented as a memory or storage device. The signal processor 13 may include a modulator and a demodulator for communication by a scheme other than OFDM. A clock generator which generates a clock may be included to manage internal time of the wireless communication device 1. Additionally, a clock acquirer which acquires a clock from the outside may be included. The same applies to the embodiments below.

### Second Embodiment

A second embodiment makes accuracy in detecting a symbol timing for an OFDM reception signal and accuracy in detecting a symbol timing for a leak signal higher than in the first embodiment.

The second embodiment is different from the first embodiment in that a wireless communication device 1 transmits a signal ordering a communication partner to temporarily stop transmission. Components of the wireless communication device 1 may be the same as those in the first embodiment. A description of similarities to the first embodiment will be omitted. A signal giving an order to temporarily stop transmission will be hereinafter referred to as a transmission stop signal.

If noise contamination, an interference by a different signal, or the like occurs in an OFDM signal, a symbol timing for which is to be detected, accuracy in symbol timing detection tends to decrease. Thus, if an attempt is made to detect a symbol timing for an OFDM reception signal from a signal which is generated due to interference by a leak signal with the OFDM reception signal, accuracy in the detection may be low. At the time of detecting a symbol timing for a leak signal, an OFDM reception signal interferes with the leak signal, and accuracy in the detection may be low.

As described above, if an OFDM reception signal and a leak signal interfere with each other, and a symbol timing for the leak signal and a symbol timing for the OFDM reception signal cannot be detected with high accuracy, transmission by one of two wireless communication devices 1 which perform wireless communication may be stopped. For example, a transmission stop signal may be transmitted to a communication partner, and the communication partner may be caused to operate to temporarily stop transmission operation when the communication partner receives the transmission stop signal.

Incidentally, a transmission stop signal may be included in an OFDM transmission signal. Alternatively, a transmission stop signal may be separately sent. A modulation scheme for a transmission stop signal may not be OFDM.

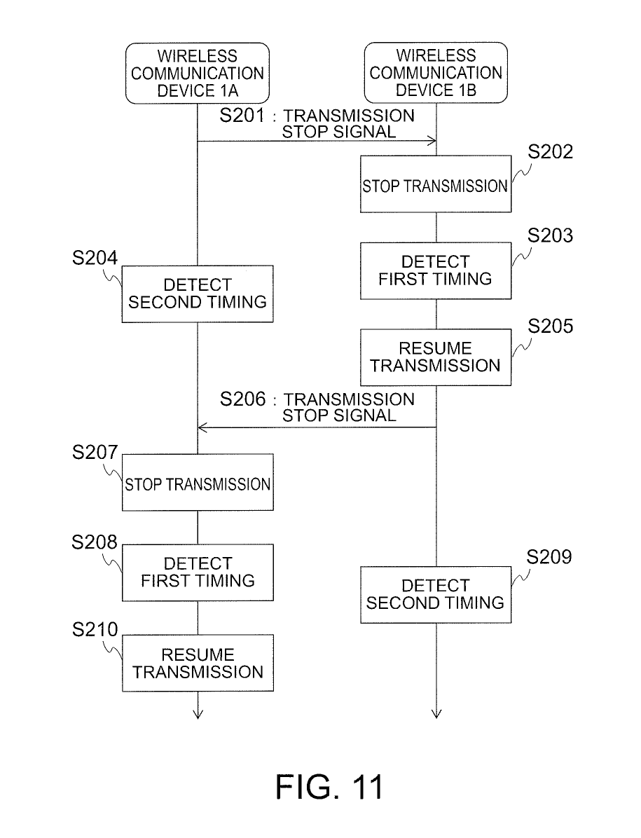

The flow of communication in a case using a transmission stop signal will be described. FIG. 11 is a chart illustrating an example of a sequence for a case where the wireless communication device 1 transmits a transmission stop signal. First, a wireless communication device 1A transmits a transmission stop signal to a wireless communication device 1B (S201). Incidentally, the wireless communication device 1 that is the first to transmit a transmission stop signal may be either one of the two wireless communication devices 1.

The wireless communication device 1B having received the transmission stop signal stops transmission (S202). With the stoppage of transmission by the wireless communication device 1B, a leak signal ceases to flow into a signal processor 13B of the wireless communication device 1B. That is, a first timing detector 132B of the wireless communication device 1B detects a symbol timing for an OFDM reception signal from the OFDM reception signal without interference by a leak signal (S203).

On the other hand, The wireless communication device 1A does not receive an OFDM signal any more from the wireless communication device 1B sometime after the stoppage of transmission by the wireless communication device 1B. That is, a second timing detector 133A of the wireless communication device 1A detects a symbol timing for a leak signal from the leak signal without interference by an OFDM reception signal (S204). Thus, the wireless communication device 1 that is a transmitter of the transmission stop signal improves in accuracy in detecting a symbol timing for a leak signal, and the wireless communication device 1 that is a receiver of the transmission stop signal improves in accuracy in detecting a symbol timing for an OFDM reception signal.

After that, the wireless communication device 1B resumes transmission (S205). Transmission may be resumed after a lapse of a fixed time period since the stoppage of transmission. Alternatively, a signal giving an order for transmission resumption may be transmitted to the wireless communication device 1B after the wireless communication device 1A successfully detects a symbol timing for a leak signal.

After the resumption of transmission, the wireless communication device 1B transmits a transmission stop signal (S206). The wireless communication device 1A having received the transmission stop signal stops transmission (S207). With the stoppage of transmission by the wireless communication device 1A, a first timing detector 132A of the wireless communication device 1A detects a symbol timing for an OFDM reception signal from the OFDM reception signal without interference by a leak signal (S208). A second timing detector 133B of the wireless communication device 1B detects a symbol timing for a leak signal from the leak signal without interference by an OFDM reception signal (S209). Thereby, the wireless communication device 1 that is a transmitter of the transmission stop signal improves in accuracy in detecting a symbol timing for a leak signal, and the wireless communication device 1 that is a receiver of the transmission stop signal improves in accuracy in detecting a symbol timing for an OFDM reception signal.

The wireless communication device 1A resumes transmission (S210). With transmission of a transmission stop signal to each other in the above-described manner, both the wireless communication devices 1 can improve both in the accuracy in detecting a symbol timing for an OFDM reception signal and in the accuracy in detecting a symbol timing for a leak signal. Measurement of a symbol timing can be completed in a shorter time period than in the first embodiment.

Incidentally, although both the wireless communication devices 1 transmit transmission stop signals in the above description, one wireless communication device 1 alone may transmit a transmission stop signal. For example, the need for a transmission stop signal from the other may be eliminated by an explicit method, such as including a message that transmission is to be stopped after a fixed time period in a transmission stop signal. Alternatively, the need for a transmission stop signal from the other may be eliminated by an implicit method, such as making in advance an arrangement that the other has to stop transmission after one resumes transmission. In this case, the process of S206 of the sequence chart illustrated in FIG. 11 is skipped, and the process of S207 and the subsequent steps are automatically performed. Thus, if one alone transmits a transmission stop signal, both the wireless communication devices 1 can improve both in the accuracy in detecting a symbol timing for an OFDM reception signal and in the accuracy in detecting a symbol timing for a leak signal.

Incidentally, a length of a time period during which transmission is temporarily stopped may be defined as appropriate within a range which does not affect communication. Alternatively, the length of a time period during which transmission is temporarily stopped may be set to an integer multiple of a symbol length of an OFDM transmission signal. With this setting, an offset does not vary after resumption of transmission, which eliminates the need to reduce an absolute value of the offset again after the resumption of transmission.

A timing for transmission of a transmission stop signal, a period during which transmission is temporarily stopped, and the like may be defined in advance in an OFDM parameter determiner 134. The OFDM parameter determiner 134 may determine whether to transmit a transmission stop signal. For example, the OFDM parameter determiner 134 may determine transmission of a transmission stop signal in, e.g., a case where a value of an offset does not fall below a predetermined value even after a symbol length is changed a plurality of times or a case where communication quality illustrated in FIGS. 9 and 10 does not meet a condition.

A transmission stop signal may be modulated by an OFDM modulator 135 using OFDM and be transmitted via a transmitter 11. Alternatively, a modulator (not illustrated) may modulate a transmission stop signal by a scheme other than OFDM.

As described above, according to the present embodiment, transmission of an OFDM transmission signal is temporarily stopped. This allows improvement of accuracy in detecting a symbol timing for an OFDM reception signal and a symbol timing for a leak signal.

### Third Embodiment

In a third embodiment, two wireless communication devices 1 which perform communication are identical in a symbol length of an OFDM transmission signal.

The third embodiment is different from the first and second embodiments in that information on a symbol length is transmitted and that the two wireless communication devices 1 are brought into coincidence in symbol length. Components may be the same as those in the first and second embodiments. A description of similarities to the first and second embodiments will be omitted.

The wireless communication devices 1 that perform communication are preferably identical in a symbol length of an OFDM transmission signal. If the wireless communication devices 1 are different in symbol length, an offset varies with time. To keep the offset within an allowable range in this case, a symbol length of an OFDM transmission signal needs to be varied in accordance with variation in offset. This increases the number of times a process of determining an appropriate symbol length is performed and increases a load on the wireless communication device 1. Therefore, the wireless communication device 1 according to the present embodiment reduces the amount of variation in offset by changing a symbol length to the same value as a symbol length of a communication partner or bringing the symbol length closer to the value. This simplifies symbol length control.

Various methods are conceivable as a symbol length change method for reducing the amount of variation in offset, and the symbol length change method may be defined as appropriate. For example, there is available a method in which the wireless communication devices 1 that perform communication calculate a symbol length using the same calculation method. Alternatively, a symbol length of a communication partner may be equalized with a symbol length by notifying information on the symbol length to the communication partner. Information on a symbol length may be separately transmitted or may be included in an OFDM signal together with different data.

For example, if a wireless communication device 1A desires to change a symbol length, the wireless communication device 1A gives a notification of information on a target symbol length to be changed to a wireless communication device 1B. After that, both the wireless communication device 1A and the wireless communication device 1B may change their symbol lengths to the symbol length in the notification given by the wireless communication device 1A.

Both the wireless communication devices 1 may transmit an order for symbol length change. However, if both the wireless communication devices 1 are capable of symbol length change, different symbol lengths may be set when the wireless communication devices 1 transmit orders to each other. For this reason, a master-slave mode may be adopted. One of the two wireless communication devices 1 may serve as a master to determine a symbol length, and the other wireless communication device 1 may serve as a slave to change (suit) a symbol length to the determined symbol length.

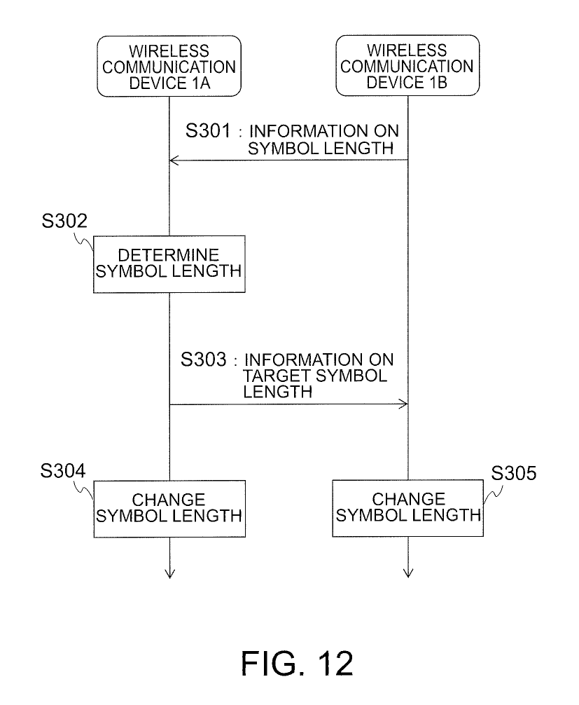

FIG. 12 is a chart illustrating an example of a sequence for a case where the two wireless communication devices 1 come into coincidence in symbol length. FIG. 12 illustrates a case where the wireless communication device 1A is a master (coordinator) while the wireless communication device 1B is a slave.

The wireless communication device 1B as the slave sends information including a symbol length to the wireless communication device 1A as the master (S301). The information may be periodically sent at predetermined times or may be sent upon occurrence of a predetermined event. Alternatively, the information may be sent upon receipt of a query from the wireless communication device 1A as the master.

The wireless communication device 1A determines a symbol length value in view of the symbol length of the wireless communication device 1B and a symbol length of the wireless communication device 1A (S302). The wireless communication device 1A sends information including the determined symbol length value to the wireless communication device 1B (S303) to change the symbol length to the determined value (S304). The wireless communication device 1B also changes the symbol length to a received value. In this manner, the two wireless communication devices 1 are brought into coincidence in symbol length.

In the master-slave mode, the wireless communication device 1 as a master can determine a symbol length in view of a symbol length calculated in the wireless communication device 1 as a slave. Incidentally, the process of S301 in the sequence chart is skipped if symbol lengths for both the wireless communication devices 1 are brought into coincidence with a symbol length calculated by one wireless communication device 1.

Timings for symbol length change are preferably the same. Thus, the timings for change may be controlled. For example, a time of symbol length change may be specified at the time of notification of a symbol length. Alternatively, the wireless communication device 1 as a master may keep track of a symbol number of an OFDM transmission signal on the other end and specify a symbol number, for which a symbol length is to be changed.

A timing for transmission of information on a symbol length, master or slave settings, and the like may be defined in advance in an OFDM parameter determiner 134.

Information on a symbol length may be modulated by an OFDM modulator 135 using OFDM and be transmitted via a transmitter 11. Alternatively, a modulator (not illustrated) may modulate information on a symbol length by a scheme other than OFDM.

As described above, according to the present embodiment, two wireless communication devices 1 share symbol length information and are identical in a symbol length of an OFDM transmission signal. This allows a reduction in the number of symbol length changes.

### Fourth Embodiment

In a fourth embodiment, a timing for transmission of an OFDM transmission signal is brought into synchronization with a timing for a communication partner. This configuration makes an appropriate symbol length easier to determine in two wireless communication devices 1 than in the embodiments described so far.

The fourth embodiment is different from the embodiments in that information on a transmission timing is transmitted and that transmission timings are brought into synchronization in the two wireless communication devices 1. Components may be the same as those in the embodiments. A description of similarities to the embodiments will be omitted.

The wireless communication devices 1 that perform communication are preferably identical in a timing for transmission of an OFDM transmission signal. If wireless communication devices 1A and 1B are identical in the timing for transmission of an OFDM transmission signal, an offset calculated in the wireless communication device 1A and an offset calculated in the wireless communication device 1B have the same values. On the other hand, if the wireless communication devices 1A and 1B are not identical in the timing for transmission of an OFDM transmission signal, the offset calculated in the wireless communication device 1A and the offset calculated in the wireless communication device 1B have different values. Thus, if the wireless communication devices 1A and 1B are not identical in the timing, absolute values of the two offsets need to be reduced and symbol length determination is more difficult than in a case where the wireless communication devices 1A and 1B are identical in the timing.

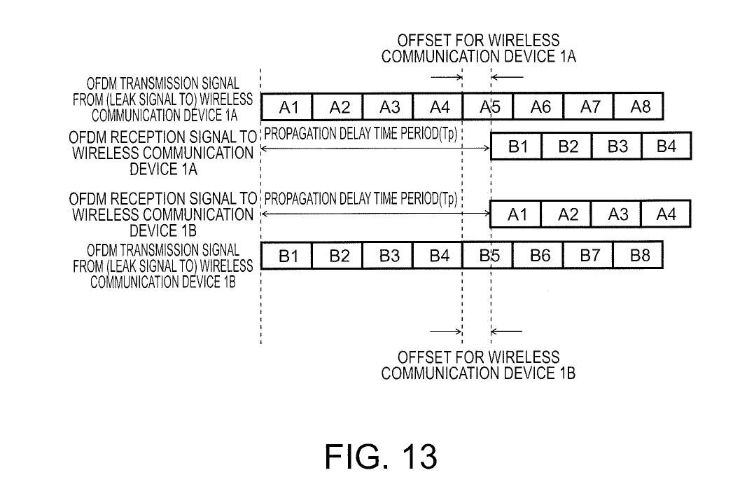

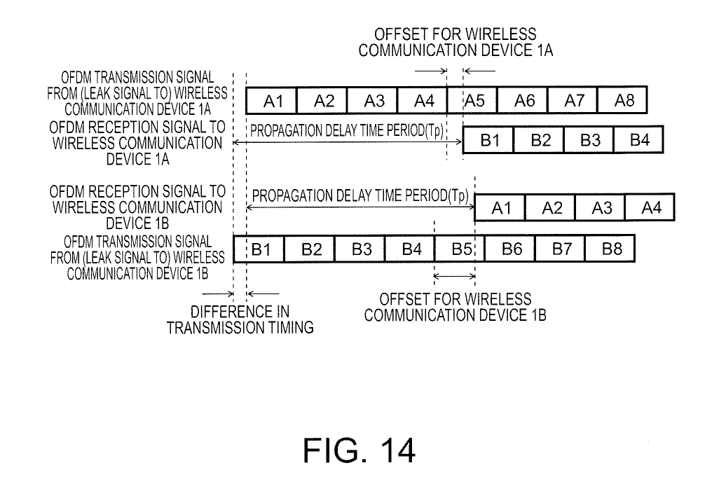

FIGS. 13 and 14 are diagrams for explaining a relationship between a transmission timing for an OFDM transmission signal and an offset. FIG. 13 is a diagram illustrating offsets in a case where transmission timings for an OFDM transmission signal are in synchronization. FIG. 14 is a diagram illustrating offsets in a case where the transmission timings for an OFDM transmission signal are out of synchronization.

Since a common communication path is shared, a time period required for an OFDM transmission signal from the wireless communication device 1A to arrive at the wireless communication device 1B and a time period required for an OFDM transmission signal from the wireless communication device 1B to arrive at the wireless communication device 1A are the same. That is, propagation delay time periods are the same. If the two wireless communication devices 1 perform transmission at the same timing, timings for reception by communication partners are also the same. Accordingly, offsets measured in the two wireless communication devices 1 are the same, as illustrated in FIG. 13.

On the other hand, in FIG. 14, the wireless communication device 1A transmits an OFDM transmission signal after a delay corresponding to a difference in transmission timing illustrated in FIG. 14. As described above, if transmission timings are different, the wireless communication device 1 with a later transmission timing has a later symbol timing for a leak signal, and an absolute value of an offset is smaller than in the case where the transmission timings are the same. Thus, in FIG. 14, the offset for the wireless communication device 1A is smaller by the difference in transmission timing than in the case illustrated in FIG. 13. The wireless communication device 1 with an earlier transmission timing has a later timing for reception of an OFDM reception signal, and an absolute value of an offset is larger than in the case where the transmission timings are the same. In FIG. 14, the offset for the wireless communication device 1B is larger by the difference in transmission timing than in the case illustrated in FIG. 13.

As described above, if transmission timings are different, absolute values of offsets calculated in the respective wireless communication devices 1 are different. An absolute value of an offset in one wireless communication device 1 is larger than in the case where the transmission timings are the same. Thus, symbol length determination may be difficult. The symbol length determination is made easier by causing transmission timings to coincide.

Various methods are conceivable as a method for causing transmission timings to coincide. For example, there is available a method in which two wireless communication devices 1 both start transmission at a predetermined timing. The starting of transmission may be controlled by a host processor 136, an OFDM modulator 135, or a transmitter 11. Assume that a signal processor 13 includes a clock for time recognition. The signal processor 13 may further include a time information acquirer which acquires time information for clock setting.

A method is also conceivable which receives information on a transmission timing, such as an offset measured by the wireless communication device 1 as a communication partner, estimates a difference in transmission timing on the basis of the offset, and adjusts a transmission timing on the basis of the estimated difference in transmission timing. As described above, an offset increases or decreases by a difference in transmission timing. That is, a half of a difference between an offset for a communication partner and an offset on this side is a difference in transmission timing. Thus, the wireless communication device 1 notifies a measured offset to a communication partner, thereby allowing recognition of a difference in transmission timing and synchronization of transmission timings.

Transmission timing adjustment may be performed by, for example, shifting a transmission timing for one wireless communication device 1 by an estimated difference in transmission timing. Incidentally, transmission may be temporarily stopped if transmission is delayed by the difference in transmission timing. If transmission is advanced by the difference in transmission timing, a signal to be transmitted may be deleted. Alternatively, both the wireless communication devices 1 may adjust transmission timings. Alternatively, one wireless communication device 1 may adjust a transmission timing.

A flow at the time of transmission of information on a transmission timing by the wireless communication device 1 is the same as the flow at the time of the symbol length coincidence described in the third embodiment. Incidentally, examples of information on a transmission timing may include an offset, a symbol timing for an OFDM reception signal, and a symbol timing for a leak signal. The wireless communication device 1 having received information on a transmission timing may calculate an offset for a communication partner from a symbol timing for an OFDM reception signal and a symbol timing for a leak signal for the communication partner.

Like the symbol length coincidence described in the third embodiment, both the wireless communication devices 1 may determine a transmission timing or one as a master may determine a transmission timing. A master itself may adjust a transmission timing or may order a slave to adjust a transmission timing.

Settings on roles, such as a master, a transmission timing, and the like may be defined in advance in an OFDM parameter determiner 134. Whether to synchronize transmission timings may be judged by the OFDM parameter determiner 134. For example, a transmission timing shifts with passage of time even if the transmission timing is brought into coincidence, depending on accuracy of a clock, on which the wireless communication device 1 operates. Thus, a difference in transmission timing may be periodically calculated, and transmission timing synchronization may be performed if the difference in transmission timing becomes not less than a given fixed value.

Information on a transmission timing may be modulated by the OFDM modulator 135 using OFDM and be transmitted via the transmitter 11. Alternatively, a modulator (not illustrated) may modulate information on a transmission timing by a scheme other than OFDM.

As described above, according to the present embodiment, two wireless communication devices 1 are identical in a transmission timing for an OFDM transmission signal. This makes an appropriate symbol length easier to determine in two wireless communication devices 1.

Incidentally, a component of the wireless communication device 1 according to the present embodiment may be implemented as a piece of dedicated hardware, such as an integrated circuit (IC) bearing a processor and the like. For example, the wireless communication device 1 may include a transmission circuit which implements the transmitter 11, a reception circuit which implements a receiver 12, and a processing (control) circuit which implements the signal processor 13. An internal configuration of the signal processor 13 may be implemented by a dedicated circuit. Alternatively, a component may be implemented as a piece of software (program). If a piece of software (program) is used, the above-described embodiments can be implemented by, for example, using a general-purpose computer device as basic hardware and causing a processor, such as a central processing unit (CPU), which is mounted on a computer device to run the program.

Embodiments of the present invention have been described above. The embodiments, however, are illustrative only and are not intended to limit the scope of the invention. The new embodiments can be carried out in various other forms, and various omissions, replacements, and changes may be made without departing from the gist of the invention. The embodiments and modifications thereof are included in the scope and gist of the invention and are also included in the invention described in the claims and the scope of equivalents thereof.

A term used in the embodiments should be broadly interpreted. For example, the term “processor” may encompass a general-purpose processor, a central processing unit (CPU), a microprocessor, a digital signal processor (DSP), a controller, a microcontroller, a state machine, and the like. Under some circumstances, the term “processor” may refer to an application-specific integrated circuit, a field programmable gate array (FPGA), a programmable logic device (PLD), or the like. The term “processor” may refer to a combination of a plurality of processing devices, such as a microprocessor, a combination of a DSP and a microprocessor, or one or more microprocessors in conjunction with a DSP core.

As a different example, the term “memory” may encompass an arbitrary electronic component capable of storing electronic information. The term “memory” may refer to a random access memory (RAM), a read-only memory (ROM), a programmable read-only memory (PROM), an erasable programmable read-only memory (EPROM), an electrically erasable PROM (EEPROM), a nonvolatile random access memory (NVRAM), a flash memory, or a magnetic or optical data storage. The memories are processor-readable. If a processor performs reading or writing of information from or to a memory, or both, the memory can be said to electrically communicate with the processor. The memory may be integrated with the processor. Even in this case, the memory can be said to electrically communicate with the processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wireless communication device comprising:
a transmitter configured to transmit a first OFDM signal;
a receiver configured to receive a second OFDM signal; and
a signal processor configured to:
detect a first timing that is a symbol timing for the first OFDM signal,
detect a second timing that is a symbol timing for the second OFDM signal,
determine a setup value for a symbol length of a new first OFDM signal on the basis of the first timing and the second timing, and
generate the new first OFDM signal, the symbol length of which is adjusted to the setup value.

2. The wireless communication device according to claim 1, wherein
the first timing is detected using the first OFDM signal leaked around to the receiver.

3. The wireless communication device according to claim 1, wherein
the setup value is determined such that an absolute value of a difference between the first timing for the new first OFDM signal and the second timing is smaller than an absolute value of a difference between the first timing for the first OFDM signal previous to the new first OFDM signal and the second timing.

4. The wireless communication device according to claim 1, wherein
the setup value is repeatedly changed until the difference between the first timing and the second timing falls within an allowable range.

5. The wireless communication device according to claim 3, wherein
the setup value is determined on the basis of a propagation delay time period of the second OFDM signal.

6. The wireless communication device according to claim 5, wherein
the receiver receives an identifier for symbol identification included in the second OFDM signal, and
the signal processor calculates the propagation delay time period of the second OFDM signal on the basis of the identifier.

7. The wireless communication device according to claim 1, wherein
a symbol length of the first OFDM signal is changed to the setup value by adjusting a length for a guard interval included in the first OFDM signal.

8. The wireless communication device according to claim 1, wherein
the transmitter transmits a transmission stop signal ordering a first communication partner to temporarily stop transmission, and
the first timing is detected while the receiver does not receive the second OFDM signal from the first communication partner in accordance with the transmission stop signal.

9. The wireless communication device according to claim 1, wherein
when the receiver receives a transmission stop signal ordering the receiver to temporarily stop transmission, transmission of the first OFDM signal is temporarily stopped.

10. The wireless communication device according to claim 9, wherein
the second timing is detected while the transmission of the first OFDM signal is temporarily stopped.

11. The wireless communication device according to claim 8, wherein
a length of a time period for temporary stoppage ordered by the transmission stop signal is an integer multiple of the symbol length of the first OFDM signal.

12. The wireless communication device according to claim 1, wherein
the transmitter transmits a signal about the setup value.

13. The wireless communication device according to claim 1, wherein
when the receiver receives a signal about a setup value of a symbol length, the signal processor adjusts the symbol length of the new first OFDM signal to the received setup value.

14. The wireless communication device according to claim 1, wherein
the transmitter transmits the first OFDM signal at a timing specified by the second communication partner or at a timing specified to the second communication partner to transmit the first OFDM signal at a same timing as transmission by a second communication partner.

15. A wireless communication method to be performed by a wireless communication device including a transmitter configured to transmit a first OFDM signal and a receiver configured to receive a second OFDM signal, the method comprising:
detecting a first timing that is a symbol timing for the first OFDM signal;
detecting a second timing that is a symbol timing for the second OFDM signal;
determining a setup value for a symbol length of a new first OFDM signal on the basis of the first timing and the second timing; and
generating the new first OFDM signal, the symbol length of which is adjusted to the setup value.
